(19) United States
(12) Patent Application Publication
(10) Pub. No.: US 2007/0136429 A1
(43) Pub. Date: Jun. 14, 2007

(54) Methods and systems for building participant profiles

(76) Inventors: Leslie R. Fine, Palo Alto, CA (US); Bernardo A. Huberman, Palo Alto, CA (US); Eytan Adar, Mountain View, CA (US); Lada Adamic, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/299,086

(22) Filed: Dec. 9, 2005

(51) Int. Cl. G06F 15/16

(52) U.S. Cl. 709/206

(57) ABSTRACT

A method, apparatus, and system are disclosed for selecting cohorts to participate in information aggregation. One embodiment is a method for software execution. The method includes building a profile of plural individuals from information extracted from documents that include names of the individuals; disambiguating ambiguous names of the plural individuals in the documents; and selecting cohorts from the plural individuals to participate in information aggregation.

### BACKGROUND

Aggregating large amounts of information is difficult since it is often dispersed across a vast number of people and places. Information exists in numerous different locations throughout the internet, electronic databases, and corporate intranets, to name a few examples. Organizations and companies use various techniques to collect and aggregate this information so it can be used in a useful manner.

As one example, companies use aggregated information to accurately predict future outcomes associated with uncertain events. A variety of individuals and organizations utilize the prediction of future outcomes to provide guidance in the study of regularities that underlie natural and social phenomena. As a result, large resources are devoted to producing reliable forecasts of technology trends, revenues, growth, and financial markets, to name a few examples. The success of such forecasts, however, requires that relevant information is accurately aggregated.

For various reasons, traditional attempts to predict future outcomes of uncertain events are not sufficiently accurate. As one example, predictions are adversely impacted by various characteristics of the participants. Adverse impacts are especially prevalent in predictions that involve numerous different participants. Biases or risk tendencies vary from person to person, and these characteristics impact analysis and decision making. For instance, the risk attitude of an individual effects his or her prediction of an event. Risk-adverse individuals tend to report a probability distribution that is flat since such individuals spread risk among all possible outcomes. On the other hand, risk-prone individuals tend to report a probability distribution that is peaked since such individuals concentrate risk among few possible outcomes.

To complicate matters further, individuals are often selected to participate in information aggregation in an ad hoc, unscientific, or even random manner. In some participation schemes, individuals choose participants based on personal knowledge of the participants. Either the person running the prediction or someone internal to the group simply chooses cohorts based on whether such cohorts appear to be good fits. The tools for selecting cohorts are thus prone to biases of the selecting individuals and limited by personal knowledge of the selecting individuals.

### BRIEF DESCRIPTION OF THE DRAWINGS

FIG. 1 illustrates an exemplary system in accordance with an embodiment of the present invention.

FIG. 2 illustrates an exemplary flow diagram for discovering and selecting participants to participate in a particular task in accordance with an embodiment of the present invention.

FIG. 3 illustrates an exemplary flow diagram for building profiles and disambiguating names in accordance with an embodiment of the present invention.

FIG. 4 illustrates an exemplary flow diagram for constructing a social network in accordance with an embodiment of the present invention.

FIG. 5 illustrates an exemplary flow diagram for conducting information aggregation with a selected group in accordance with an embodiment of the present invention.

### DETAILED DESCRIPTION

Exemplary embodiments in accordance with the present invention are directed to systems, methods, and apparatus for discovering and selecting an optimal group of individuals or cohorts to participate in a particular task. In one exemplary embodiment, profiles for individuals are built, and variant or ambiguous names are resolved with a disambiguating algorithm. Further, a social network is built for the individuals. The selected individuals are used with various knowledge and/or social networking tools or information aggregation tools to achieve the designated task.

These embodiments are utilized with various systems and apparatus. FIG. 1 illustrates an exemplary embodiment as a system 10 for discovering and selecting cohorts to participate in a particular task. For discussion purposes, the particular task is described as information aggregation in accordance with an exemplary embodiment of the invention.

The system 10 includes a host computer system 20 and a repository, warehouse, or database 30. The host computer system 20 comprises a processing unit 50 (such as one or more processors of central processing units, CPUs) for controlling the overall operation of memory 60 (such as random access memory (RAM) for temporary data storage and read only memory (ROM) for permanent data storage) and people find and information aggregation algorithms for discovering and selecting cohorts to participate in information aggregation. The memory 60, for example, stores data, control programs, and other data associate with the host computer system 20. In some embodiments, the memory 60 stores the people find and information aggregation algorithms 70. The processing unit 50 communicates with memory 60, data base 30, people find and information aggregation algorithms 70, and many other components via buses 90.

Embodiments in accordance with the present invention are not limited to any particular type or number of databases and/or host computer systems. The host computer system, for example, includes various portable and non-portable computers and/or electronic devices. Exemplary host computer systems include, but are not limited to, computers (portable and non-portable), servers, main frame computers, distributed computing devices, laptops, and other electronic devices and systems whether such devices and systems are portable or non-portable.

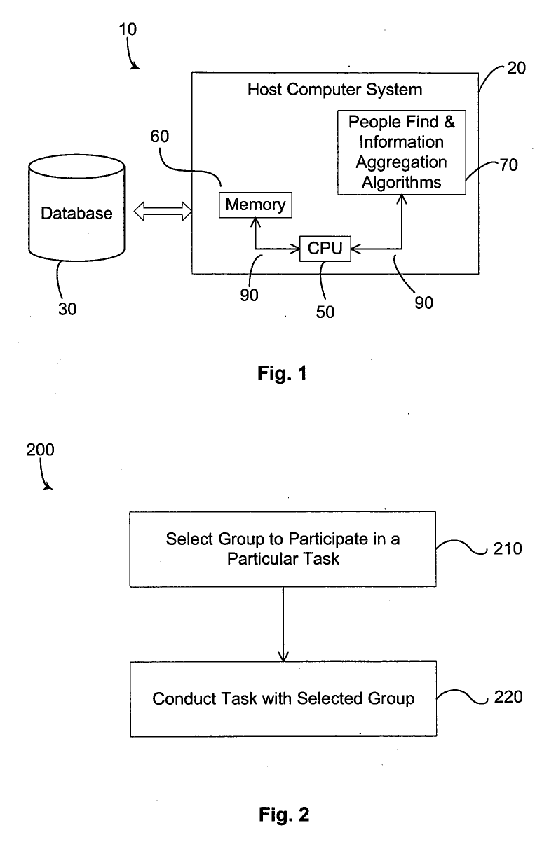

FIG. 2 illustrates an exemplary flow diagram 200 for discovering and selecting participants to participate in a particular task, such as information aggregation. The flow diagram has two stages: selection of participants (one example discussed in connection with block 210) and utilization of the selected participants in a task (one example discussed in connection with block 220).

According to block 210, an optimal number and composition of participants are selected or discovered for participation in a designated task. In one embodiment, the participants consist of a group or cohorts (i.e., a group of individuals having a statistical factor in common in a demographic study).

According to block 220, the selected group conducts the particular task. As used herein, the term “task” means a job, work, goal, or function given or assigned to one or more participants and/or machines. By way of example, the task is information aggregation. Information aggregation includes methods and systems for collecting, organizing, and/or managing information from different sources (example, individuals and/or documents). The information (example, facts, data, and/or knowledge) is acquired, supplied, and/or communicated about something or somebody. By way of example, information aggregation includes methods and systems for accurately predicting future outcomes associated with uncertain situations or events, extracting information from plural participants, collecting data from committees and documents, collating or assembling information, to name a few examples. Embodiments in accordance with the invention are not limited to information aggregation. The selected participants can be used to perform a variety of tasks, such as various knowledge and/or social networking methods and systems and forecasts of technology trends, revenues, growth, and financial markets, to name a few examples.

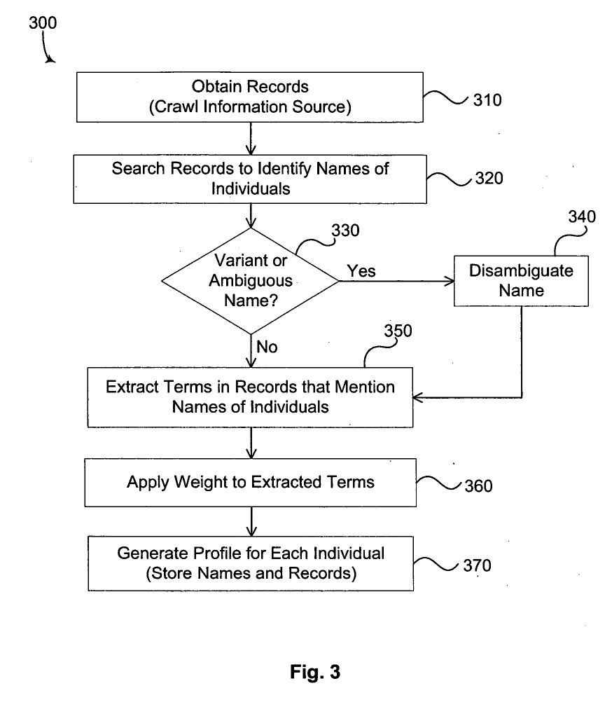

FIG. 3 illustrates one exemplary embodiment for discovering, selecting, and storing participants. The embodiment illustrates a flow diagram 300 for building profiles and disambiguating names.

According to block 310, records or documents for individuals are obtained or discovered. As used herein, the term “document” and “record” means a writing that provides information or acts as a record of events or arrangements. By way of example, “documents” and “records” include, but are not limited to, electronic files (data files, text files, program files, etc.), stored information (such as information stored in a database or memory), text, computer files created with an application program, websites, images, emails, publications, and other writings.

In one exemplary embodiment, a search engine or web crawler is used to retrieve records or documents relating to individuals. As one example, the search engine is a program stored in the memory of computer system (such as host computer system 20 of FIG. 1). The program assists a user or computing device in accessing files stored on a computer, for example a server on the World Wide Web (internet), servers on an intranet (i.e., a network belonging to an organization), servers on an extranet (i.e., an intranet that is partially accessible to authorized outsiders), or other networks or sources of data. The search engine enables a user to request and obtain information or media content having specific criteria. The request, for example, can be entered as keywords or a query. Upon receiving the query, the search engine retrieves documents, files, or information relevant to the query.

In one exemplary embodiment, a web crawler crawls or searches the network and builds an associated database (such as database 30 in FIG. 1). The web crawler is a program that browses or crawls networks, such as the internet, in a methodical and automated manner in order to collect or retrieve data for storage. For example, the web crawler can crawl internal and external web servers of a company to retrieve documents (example, HTML (Hyper Text Markup Language), PDF (Portable Document Format), Word, PowerPoint, etc.) of employees.

According to block 320, the records are searched to identify names of individuals. The names of potential participants (such as employees of a company), variants of these names, and email addresses of these names are obtained. By way of example, such names and email addresses are obtained from an enterprise directory of a company and stored as a list. All of the documents or records discovered during the web crawl (or otherwise obtained according to block 310) are searched to identify the names and email addresses corresponding to the identified individuals (example, individuals on the list).

As names and emails in the documents are identified, a record is made on the certainty of such names and emails. In other words, a determination is made about whether such names and emails unambiguously identify a particular individual (example, individuals on the list). According to block 330, an inquiry is made as to whether identified names are ambiguous.

Email addresses by their nature are unambiguous. Some names, however, include variants. For example, the name William includes the variants Bill, Billy, or Will. Further, initials can be used in place of first names. Multiple documents or records can include variants of one or more individuals. When two or more individuals share the same name variant, the names are disambiguated to determine which individual is actually mentioned in a record. Consider a scenario wherein two different people have the name William Smith. During the information gathering stage, several documents are identified to include the names Bill Smith, W. Smith, and William Smith. Embodiments in accordance with the invention disambiguate such variants.

In one exemplary embodiment, ambiguous names or variants are compared with their corresponding position in an organization or company with the names of other individuals found in the same documents. Consider the scenario wherein the first William Smith works in an Imaging and Printing division, and the second William Smith works in a Human Relations division. Other names mentioned in the document can provide a clue as to whether the first or second William Smith is being mentioned. For example, if other names in the document also work in the Imaging and Printing Division, then the first William Smith is assumed. By contrast, if other names appearing in the document are associated with the Human Relations division, then the second William Smith is assumed. As another example, ambiguous names or variants are compared with known personal or professional information. For instance, the first William Smith may be a vice president, and the second William Smith an accountant. Titles of individuals (i.e., designation of position in a company or organization) provide a clue to disambiguate names. Further, the acronyms VP or CPA associated with the names provide a clue to disambiguate the names. Thus, the names are compared with their position in an organization hierarchy. As another example, the document is searched for an email address that is associated with the name. Names associated with or positively linked to email addresses are disambiguated since email addresses are unique.

Embodiments in accordance with the invention are not limited to particular methodologies to determine variants and/or disambiguate names. In one exemplary, the tasks of determining variants and disambiguating names are separately performed, and in other embodiments these tasks are concurrently performed. Further, in one exemplary embodiment, information in the documents is used to disambiguate the names and/or to provide clues to assist in disambiguating the names. For example, text or images (example, a photograph) associated with or surrounding the ambiguous names or variants is used to identify the correct individual. In other words, information in the document itself provides a clue for determining or disambiguating the name of the individual. Such information includes, but is not limited to, names of other individuals, email addresses, and personal or business information of the individual (addresses, phone numbers, titles, publications, professional affiliations, nicknames, dates, etc.).

If variant or ambiguous names exist in the documents, then according to block 340, such names are disambiguated (i.e., ambiguity is resolved to establish an accurate or single interpretation). If no variants or ambiguous names exist (or names have been disambiguated), then according to block 350, extract terms in the record that mention names of individuals. Profiles are built for individuals by extracting terms (keywords, phrases, images, etc.) found in documents that mention the name of the individual.

According to block 360, a weight is applied to each term extracted from the document. In one exemplary embodiment, each extracted term is weighted or ranked by how frequently it is mentioned in the same document as the individual. Further, an inverse proportion is applied to how common the term is. Common terms are assigned little weight, and less common terms are assigned a greater weight.

According to block 370, profiles are generated for each individual. In one exemplary embodiment, the profile for each individual includes a ranked list of terms that were extracted and weighted according blocks 350 and 360. In one exemplary embodiment, the terms are extracted, weighted, and ranked to reflect an area of expertise for each of the individuals. Further, while building the profiles, the documents, extracted terms, and names of the individuals are stored in a database (such as database 30 of FIG. 1).

Embodiments in accordance with the invention are not limited to performing each of the blocks 310-370. In one exemplary embodiment for example, building or generating profiles is optional. As an alternative to building profiles, the documents are directly indexed. Then the method involves performing a search query, retrieving all the relevant documents, and then ranking individuals with respect to the query based on how many of those documents contain the names of the individuals.

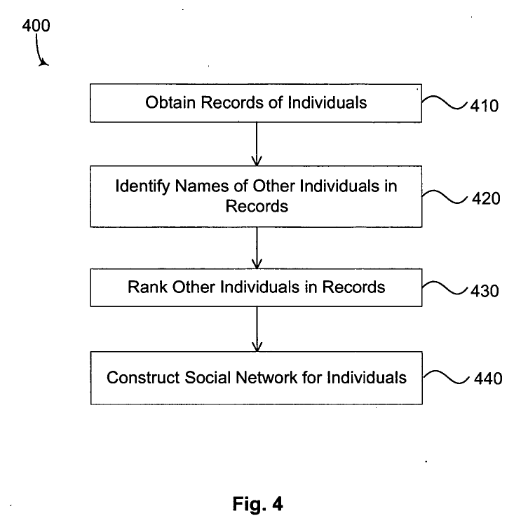

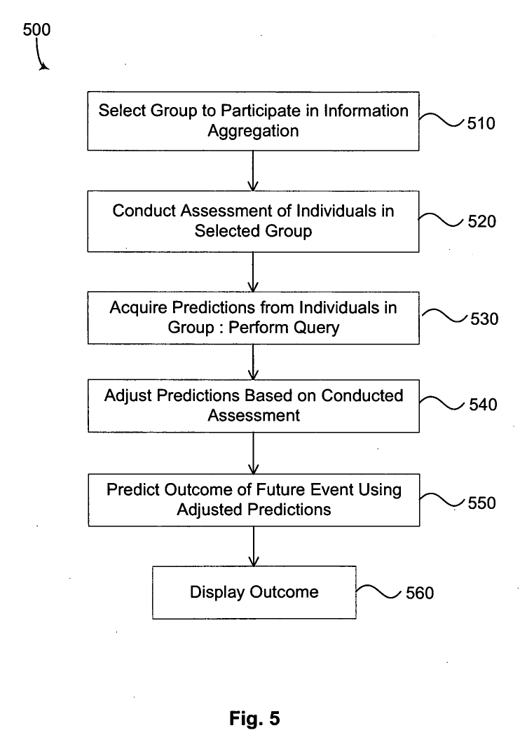

FIG. 4 illustrates an exemplary flow diagram 400 for constructing a social network for individuals. According to block 410, records for individuals are obtained or discovered. In one exemplary embodiment, the records are obtained as discussed in connection with FIG. 3. For instance, the records are obtained from a database (example, database 30 of FIG. 1) after the profiles are being constructed.

According to block 420, the names of other individuals appearing in the records are identified. For instance, if a social network is being built for an employee, all individuals mentioned in the same documents as the employee are extracted. These extracted individuals are associated with the employee and form part of the social network since both the employee and individuals are discovered in the same document.

In one exemplary embodiment, all other individuals appearing in the records are extracted as part of the social network. In other exemplary embodiment, less than all individuals are extracted. For example, some individuals are removed from the extraction process depending on the type, size, or composition of the social network being built. As one example, only individuals that are employees of a particular company or organization are extracted. In this scenario, a social network of co-workers or colleagues is built.

According to block 430, the other individuals identified in the records are weighted or ranked. In one exemplary embodiment, each individual in the network is assigned a co-occurrence weight that reflects a number of times their name occurs in the same document as the individual.

In another exemplary embodiment, the other individuals identified in the records are weighted or ranked according to a combination of two scores. One score is the co-occurrence weight reflecting a number of times a name appears in the document. The other score is a prediction for how likely two individuals are to have a professional or personal relationship (example, a business relationship). The prediction score is obtained from a prediction model that takes into account various factors, such as how close two individuals are in the organizational hierarchy and/or how large an overlap exists in the social network of the two individuals. For example, if the two individuals collaborate with many of the same people, the prediction model predicts that these two individuals also likely work with one another. The combination of both the co-occurrence weight and the prediction score force spurious results to the bottom of the social network list while placing more likely collaborators at the top of the social network list.

According to block 440, a social network is constructed for the individuals. Social networks are constructed for all individuals or a subset of the individuals for whom records are obtained.

The stored profiles and social networks according to FIGS. 3 and 4 are utilized in a wide variety of embodiments in accordance with the present invention. The profiles and social networks enable users to select participants in a scientific and quantitative manner. Method and systems for selecting cohorts or discovering individuals (such as experts) are less prone to biases of the selecting individuals or limited by personal knowledge of the selecting individuals. For instance, some biases are eliminated since the profiles and social networks are constructed from electronic documents, as opposed to using opinions or guesswork of individuals.

In one embodiment, the profiles and social networks are used to identify experts, cohorts, or groups of individuals so users can search and discover people with expertise on a particular topic. Upon receiving a query, documents matching the query are discovered. A list of all individuals who were mentioned in the documents is then retrieved (example, from the database 30 of FIG. 1). The retrieved names of individuals are ranked by the number of documents that both match the query and contain the name of the individual. The search results are presented, for example, in an accordion interface so users can expand each result to obtain more information. For instance, clicking on a link to a page below the name of an individual shows a list of all pages matching both the query and the name of the individual. Clicking on a document title opens that document in a new window. Alternatively, results are displayed according to department or organization. The departments are ranked by the number of pages where the names of one or more of its members occur.

In another exemplary embodiment, the profiles and social networks are used to provide contact information, biographies, publications, etc. for particular individuals. Such embodiments enable a user to find more information on a known individual. In one embodiment, the user clicks on the name of an individual in the search results or submits a name of an individual as a query. Upon receiving a name of an individual, the database is searched and information about the individual (such as a list of all the documents in which the name of individual occurs) is returned.

In yet another exemplary embodiment, the social networks provide a list of related individuals in the search results to a query. A social network is used to identify shared contacts or longer chains of collaborators to the experts. The list of experts is re-ranked according to how close the user making the query is to them. As an example, the social network data is useful for managers or business people to discover or investigate whether an area of expertise is fragmented. In other words, are particular employees working together, or are these employees in isolated groups.

In yet other embodiments, the profiles and social networks are used to conduct particular task, such as tasks discussed in connection with FIG. 2. By way of example, FIG. 5 illustrates an exemplary flow diagram 500 for conducting a particular task of information aggregation with a selected group. One exemplary embodiment is a method of predicting future outcomes of uncertain events in which a number of individuals participate. The probability of a future uncertain event outcome is assessed by analyzing the personal characteristics or personal and public knowledge of participants and performing an aggregation (e.g., nonlinear aggregation) of their predictions. The aggregation includes various factors, such as, but not limited to, the ability of participants to analyze information, risk attitudes of participants, public and private knowledge of the participants, biases, and other factors.

According to block 510, a group of individuals is selected to participate in the information aggregation. Preferably, the group is selected using the profiles and social networks discussed in connection with FIGS. 3 and 4.

According to block 520, the selected individuals are assessed. In one exemplary embodiment, an information market is conducted to elicit characteristics of participants (example, individual risk attitudes, information analysis abilities, relevant behavioral information, access to information, etc.). As an example, conducting an information market includes the creation of an artificial market in which financial instruments are utilized. The financial instruments correspond to a future real world event or state. The financial instrument is traded (example, bought and sold) in the information market and if the real world state or event occurs, the financial instrument pays a reward to the individual.

Characteristics of the participants are extracted as the selected individuals participate in the information market. In one embodiment, the extracted characteristics of the participants include risk attitudes and ability to interpret information. For example, the participant characteristics are extracted by correlating observed behavior to accepted characteristic tendencies. Participants that are risk inclined tend to concentrate a significant amount of their resources on fewer possible outcomes with the promise of a greater reward, and risk adverse individuals are more likely to place their resources over diverse possible outcomes with the possibility of smaller reward. In one embodiment of the present invention, different scenarios are utilized in which participants are presented with different information and their ability to identify and respond to the quality of the information (example, good, correct, relevant information etc. versus bad, incorrect, irrelevant information etc.) is extracted. Further, the predictive ability of an individual is characterized by examining the success of the individual's transactions during the information market.

According to block 530, predictions are acquired from individuals in the group. In one exemplary embodiment, a predictive query process is performed. A predictive query process includes posing a query to the information market participants and gathering the responses. The query can be about a subject related to the information market or an unrelated subject. In one embodiment, the query asks the participants to predict a future outcome associated with an uncertain situation (example, provide a predictive probability of a future outcome occurrence). For instance, participants are asked to “vote” (indicate their belief) on the probability of an outcome by assigning limited resources (example, money, financial instrument, a ticket, a chip, etc.) to a potential outcome. Embodiments in accordance with the invention are readily adaptable to a variety of different predictive indication or “voting” configurations and mechanisms. For example, the participants are limited to “voting” for one potential outcome in one embodiment and allowed to “vote” for a plurality of potential states in another embodiment. In one exemplary implementation of the present invention, participants are asked to trade a financial instrument that corresponds to a potential future real world event or state. For example, in an embodiment in which participants “vote” by assigning money to their prediction, participants may assign some of money to one potential state and the same or different value of money to another potential state. To ensure participants are properly motivated they receive financial rewards if their predictions (“votes”) are accurate (the predicted outcome occurs).

According to block 540, the predictions are adjusted based on the results of the conducted assessments in block 520. The query responses with adjustments for participant characteristics are aggregated. In one embodiment of the present invention, the aggregation accumulates the “votes” of the participants with adjustments for the participants' characteristics information. In one exemplary implementation, the aggregation function accounts for both diverse levels of risk aversion and information analysis strengths. For example, the probability projections of the participants are aggregated after adjustments for risk tendencies, information analysis capabilities, private and public knowledge, etc.

In one exemplary embodiment, predictions are aggregated in a way that takes into account the behavioral information previously gathered. The individual reports or information is aggregated using the following nonlinear aggregation function:

$$P ( s \text{\vert} I ) = \frac{{p}_{{s}_{1}}^{{β}_{1}} {p}_{{s}_{2}}^{{β}_{2}} … {p}_{{s}_{N}}^{{β}_{N}}}{{\sum }_{∀ s} {p}_{{s}_{1}}^{{β}_{1}} {p}_{{s}_{2}}^{{β}_{2}} … {p}_{{s}_{N}}^{{β}_{N}}} \qquad ( 1 )$$

where s is a given possible state, I is the available information, and βᵢ is the exponent assigned to individual i. ledge, etc.

The role of βᵢ is to help recover the true posterior probabilities from individual i's report. The value of β for a risk neutral individual is one, as he should report the true probabilities indicated by his information. For a risk averse individual, βᵢ is greater than one so as to compensate for the flat distribution that he reports. The reverse, namely βᵢ smaller than one, applies to risk loving individuals.

In one embodiment, βᵢ is expressed in terms of both the market performance and the individual predictions and risk behavior as:
βᵢ=r(Vᵢ/σᵢ)c (2)
where r is a parameter that captures the risk attitude of the whole market and is reflected in the market prices of the assets, Vᵢ is the utility of individual i, and σᵢ is the variance of his holdings over time. The notation c is used as a normalization factor so that if r=1, Σβᵢ equals the number of players; it is chosen to make the average β equal to one. The ratio of value to risk, (Vᵢ/σᵢ), captures individual risk attitudes and predictive power. An individual's value Vᵢ is given by the market prices multiplied by his holdings, summed over all the securities. As in portfolio theory, his amount of risk can be measured by the variance of his values using normalized market prices as probabilities of the possible outcomes.

In one exemplary embodiment, the aggregation function of Equation (1) is further adjusted to distinguish between publicly held information and privately held information. The equation is adjusted to compensate for the public information. Specifically, public information is distinguished from private information so the effects of the public information are canceled when aggregating the individual predictions. Cancellation of the public information is achieved, for example, by using a coordination technique that provides incentives to individuals to reveal what they believe others will reveal (i.e., identify what information is public among the individuals). Example embodiments are discussed in U.S. patent application entitled “Eliminating Public Knowledge Biases in Small Group Predictions” having application Ser. No. 10/266,437, filed Oct. 8, 2002 and being incorporated herein by reference.

Once a mechanism for extracting public information is established, a public information generalization is added to Equation (1). By dividing the perceived probability distributions of the individuals by the distributions induced by the public information, the following function is produced:

$$P ( s \text{\vert} I ) = \frac{{( \frac{{p}_{s 1}}{{q}_{s 1}} )}^{{β}_{1}} {( \frac{{p}_{s 2}}{{q}_{s 2}} )}^{{β}_{2}} … {( \frac{{p}_{sN}}{{q}_{sN}} )}^{{β}_{N}}}{{\sum }_{∀ s} {( \frac{{p}_{s 1}}{{q}_{s 1}} )}^{{β}_{1}} {( \frac{{p}_{s 2}}{{q}_{s 2}} )}^{{β}_{2}} … {( \frac{{p}_{sN}}{{q}_{sN}} )}^{{β}_{N}}} \qquad ( 3 )$$

where the \vec{q} s are extracted from individuals' reports before they are aggregated. This function enables isolation the private information from the public information.

According to block 550, a prediction of the outcome of a future event is performed using the adjusted predictions. The adjusted predictions, for example, are based on Equations (1) and/or (3). Once the predictions are determined, the outcomes are presented or displayed according to block 560.

In one exemplary embodiment, the flow diagrams are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software (whether on the host computer system of FIG. 1, a client computer, or elsewhere) will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory, and accessed by the processor using the bus. The techniques and methods for embodying software programming code in memory, on physical media, and/or distributing software code via networks are well known and will not be further discussed herein. Further, various calculations or determinations (such as those discussed in connection with the figures are displayed, for example, on a display) for viewing by a user.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method for software execution, comprising:
building a profile of plural individuals from information extracted from documents that include names of the individuals;
disambiguating ambiguous names of the plural individuals in the documents; and
selecting cohorts from the plural individuals to participate in a task.

2) The method of claim 1 further comprising:
adjusting information received from the selected cohorts to remove public knowledge biases of the selected cohorts; and
predicting, using the adjusted information, a future outcome of an event.

3) The method of claim 1 further comprising using an email address to disambiguate ambiguous names.

4) The method of claim 1 further comprising comparing two ambiguous names in the documents with other non-ambiguous names in the documents to unambiguously identify the two ambiguous names.

5) The method of claim 1 further comprising separating private knowledge of the selected cohorts from public knowledge of the selected cohorts in order to predict an outcome of an uncertain event.

6) The method of claim 1 further comprising applying a weight to the information extracted from the documents, the weight based on how frequently an extracted word appears in the documents.

7) A method for software execution, comprising:
building a profile of plural individuals by storing terms that appear in documents that include names of the plural individuals;
building a social network for the plural individuals by extracting names from a document when the document includes a name of one of the plural individuals; and
using the profile and the social network to select a group of individuals from the plural individuals to participate in a task.

8) The method of claim 7 further comprising using the profile and the social network to identify people having an expertise on a particular topic.

9) The method of claim 7 wherein building a social network further comprises ranking extracted names from the documents according to a number of times the extracted names appear in a same document as the name of one of the plural individuals.

10) The method of claim 7 wherein building a social network further comprises predicting a likelihood that two individuals appearing in a same document are professionally associated with each other.

11) The method of claim 7 further comprising comparing an ambiguous name of two different individuals with positions of the two individuals in an organization to accurately identify to whom the ambiguous name belongs.

12) The method of claim 7 further comprising using the profile and the social network to identify co-workers having similar expertise.

13) The method of claim 7 further comprising using the profile and the social network to select a group of individuals for predicting future outcomes of uncertain events.

14) A computer system, comprising:
memory for storing an algorithm; and
processor for executing the algorithm to:
build a profile of plural individuals by storing terms that appear in documents that include names of the plural individuals;
disambiguate ambiguous names in the documents of the plural individuals; and
build a social network for the plural individuals by extracting names from the documents if a single document includes a name of one of the plural individuals.

15) The computer system of claim 14, wherein the processor further executes the algorithm to select a subset of the individuals to participate in a task.

16) The computer system of claim 14, wherein the profile is further built by storing the documents that include the names of the plural individuals.

17) The computer system of claim 14, wherein the processor further executes the algorithm to:
adjust information received from a group of plural individuals to remove public knowledge biases of the group; and
predict, using the adjusted information, a future outcome of an event.

18) A computer system, comprising:
means for building a profile of plural individuals from information extracted from documents that include names of the individuals;
means for disambiguating ambiguous names in the documents of the plural individuals;
means for building a social network for the plural individuals by extracting names from a document when the document includes a name of one of the plural individuals; and
means for using the profile and the social network to select cohorts from the plural individuals to participate in a task.

19) The computer system of claim 18 further comprising means for creating an artificial market to acquire market predictions from the cohorts to determine one of biases of the cohorts or risk tendencies of the cohorts.

20) The computer system of claim 18 further comprising means for adjusting predictions of the cohorts by distinguishing between public information known to the cohorts and private information known to the cohorts.
